(19) United States
(12) Patent Application Publication
(10) Pub. No.: US 2009/0310962 A1
(43) Pub. Date: Dec. 17, 2009

(54) Service based power and battery backup selection in a multiple dwelling unit

(76) Inventors: Marc R. Bernard, Miramar, FL (US); Douglas A. Atkinson, Ashburn, VA (US); Joseph D. Kralowetz, Clarksville, MD (US); Jeffrey Rosenwald, Frederick, MD (US); John A. Stock, Leesburg, VA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/214,121

(22) Filed: Jun. 17, 2008

(51) Int. Cl. H04B 10/08

(52) U.S. Cl. 398/38

(57) ABSTRACT

Heavy users of a Multi-Dwelling Unit Optical Network Terminal (MDU ONT) continuing to use services, such as telephone, data and video, when the MDU ONT is operating from backup power unfairly use the power available from the battery backup power supply. In other words, a heavy user uses more than his share of the power available at the battery backup power supply. Example embodiments of the present invention eliminate such unfairness by associating with each user a separate battery backup power supply dedicated to support that user's services. Therefore, the heavy user will drain his battery more quickly than a light or moderate user. In situations when power from a user's battery backup power supply is not available and an emergency or priority service is requested, the MDU ONT may allocate power from other user batteries, or its own central battery, to support the service.

### BACKGROUND OF THE INVENTION

A traditional Multi Dwelling Unit (MDU) Optical Network Terminal (ONT) employs a single integrated battery for backup power to enable the MDU ONT to provide backup services to MDU subscribers. However, a single battery can only provide enough power to an ONT to enable it to provide limited services for a certain period of time, such as eight hours of emergency dial-out services. For example, if users of certain ports continue to use a high power service, such as telephone service, when main power to the MDU ONT is disrupted, the battery for the MDU will drain rapidly and thus deny users of other ports on the MDU ONT of sufficient backup services. Supporting high power services for even a few hours may lead to added costs for supporting an MDU ONT, such as requiring additional batteries or space to support a larger backup battery, or even requiring multiple MDU ONTs.

### SUMMARY OF THE INVENTION

An embodiment of the present invention may be in the form of an apparatus or a method of providing services by a network node. The embodiment may include monitoring states of requested services from respective multiple users of a shared network node having an Access Network Interface (ANI) and multiple User Network Interfaces (UNIs). The embodiment also may include operating on power from power sources associated with the multiple users respectively contributing to power the ANI and being assigned to power the multiple UNIs. Further, the embodiment may include, based on the states of the requested services and on the contribution of the power sources associated with the respective multiple users to power the ANI and respective states of available power to power the multiple UNIs, providing levels of services to the respective multiple users.

An alternative embodiment includes a method for providing services to a user by providing services to a network node of a first user at a time a state of available backup power is inadequate to support the request of services for the first user. The method also may include making additional power available to the first user from a backup power source associated with a network node of a second user, the first and second network nodes connected to a shared network node. The method further may include collecting a fee from the first user as payment for the additional power made available.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a block diagram illustrating a network in which example embodiments of the present invention may be employed.

FIG. 1B is a block diagram illustrating an example deployment of an example embodiment of the present invention in an apartment building.

FIG. 2A is a block diagram illustrating an example embodiment network node according to an embodiment of the present invention.

FIG. 2B is a flow diagram illustrating an example embodiment method of providing services by a network node according to an embodiment of the present invention.

FIGS. 3A-3F are block diagram illustrating example embodiments of the present invention in different states of available main and backup power.

FIG. 4 is a flow diagram illustrating an example method of monitoring states of available main and backup power, and providing services under a state of backup power, according to an embodiment of the present invention.

FIG. 5 is a flow diagram illustrating an example method of detecting user activity and selectively providing services according to an embodiment of the present invention.

FIG. 6 is a block diagram illustrating a service model for a service provider to provide services to a user at a time a state of available backup power is inadequate to support the requested services and to generate revenue from the user through sale of the service provided according to the service model.

### DETAILED DESCRIPTION OF THE INVENTION

A description of example embodiments of the invention follows.

Example embodiments of the present invention provide power management that allows service interfaces to be monitored for activity/usage during power outage scenarios, monitors the type of service being used (e.g., call being made (emergency versus standard call or data activity or other)), and determines if a user is capable of powering their interface with a local battery or if there is a need to obtain some or all power from other users/sources in the Multi-Dwelling Unit Optical Network Terminal (MDU ONT) for emergency, special, or priority purposes.

In cases where power from one battery is no longer available and a user needs to make an emergency or priority call, example embodiments of the present invention allow the MDU ONT to use power from other batteries to allow a given user to make an emergency call. The MDU ONT may include a central battery to manage local functions and monitor interfaces. Alternatively, the MDU ONT may use power from all batteries associated with the user interfaces to perform certain functions and draw more power from certain batteries based on service usage. Alternatively, there are methods that do not require immediate use of any distributed batteries until there is activity on the service interface. In this scenario, the MDU monitors power and services from all interfaces. When one unit's power fails, the MDU is able to continue to power this interface by retrieving power from other interfaces that either have primary power (e.g., from an alternating current (AC) source) or sufficient battery power providing direct current (DC). This scenario may include a service provider's obtaining permission from subscribers to retrieve power as needed.

Example embodiments of the present invention employ multiple distributed batteries rather than a single battery. When main power to the MDU ONT is unavailable, users are provided services while their associated batteries are active. The MDU ONT's central battery may be used to support basic services to allow the MDU ONT to detect user activity. Alternatively, a single battery may be used and the MDU ONT may take into consideration the total hours of customer use, or even the amp-hour usage for a circuit associated with a given service interface. However, some embodiments use multiple distributed batteries to allow individual customer granularity of services when needed. Having multiple batteries decreases risk of a battery failure impacting all users, as happens in traditional ONTs having a single battery backup. Further, some embodiments of the present invention allow users to manage their own power usage and eliminates “power hogging” that can be experienced in traditional ONTs.

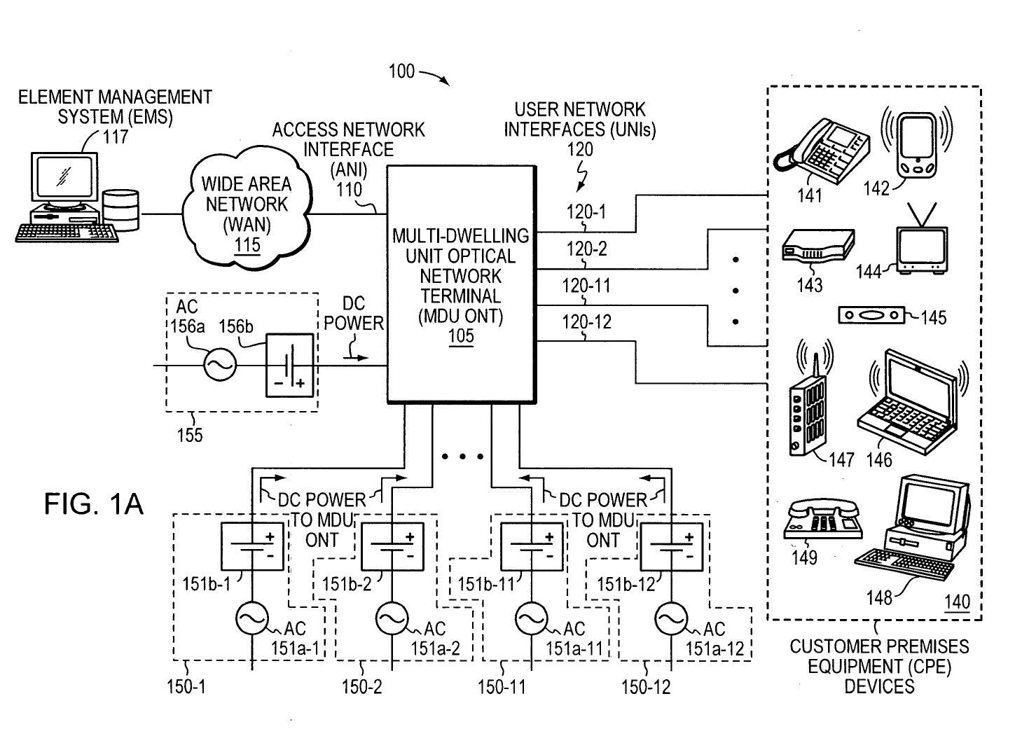

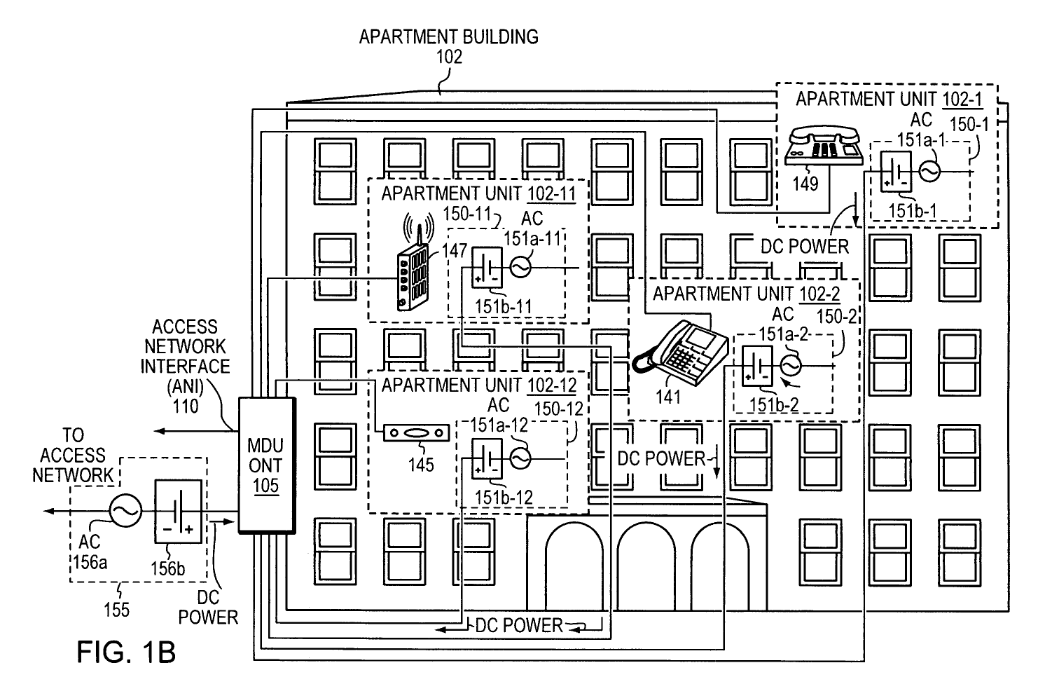

FIG. 1A is a diagram illustrating a network 100 in which example embodiments of the present invention may be employed. In this example embodiment, a node, which may be an MDU ONT 105 includes an Access Network Interface (ANI) 110 to a Wide Area Network (WAN) 115 and multiple User Network Interfaces (UNIs) 120 (e.g., twelve UNIs) to Customer Premises Equipment (CPE) devices 140. A management node, such as an Element Management System (EMS) 117, may be connected to the WAN. CPE devices 140 may include an Internet Protocol (IP) telephone 141, wireless telephone 142, Analog Telephone Adapter (ATA) 143, television 144, Set Top Box (STB) 145, laptop computer 146, Broadband Home Router (BHR) 147, Personal Computer (PC) 148, and telephone 149.

The MDU ONT 105 is connected to a power source 155, including a primary alternating current (AC) power source 156a and a battery backup power source 156b. The MDU ONT power source 155 may provide power to the MDU ONT 105 to support MDU ONT functions that are common to all UNIs (e.g., ranging) or cannot be attributed to one UNI. AC power 156a is used as a primary MDU ONT power source when available. If AC power 156a is not available at the MDU ONT power source 155, battery backup power 156b is used as a secondary backup MDU ONT power source.

The MDU ONT 105 is also connected to power sources 150-1-150-12 respectively associated with each of the UNIs 120-1-120-12, with the power sources 150-1-150-12 each having a primary AC power source 151a-1-151a-12 and a battery backup power source 151b-1-151b-12. The power sources 150-1-150-12 associated with each of the UNIs 120-1-120-12 may provide power to the MDU ONT 105 to support MDU ONT functions that may be attributed to a particular UNI (e.g., supporting services on the UNI, such as voice, data, and video services, or other similar user services that may be supported by the MDU ONT 105). AC power 151a-1-151a-12 is used as a primary power source associated with each of the UNIs 120-1-120-12 when available.

If AC power is not available at one or more of the AC power source 151a-1-151a-12 associated with each of the UNIs 120-1-120-12, battery backup power 151b-1-151b-12 is used as a secondary backup power source associated with each of the UNIs 120-1-120-12 for which AC power is not available. It should be understood that the AC power sources 151a-1-151a-12 primarily are used to charge the battery backup power sources 151b-1-151b-12. However, in certain embodiments, the AC power sources 151a-1-151a-12 may be used by the MDU ONT 105 to support services attributable to a particular UNI 120-1-120-12.

In an alternative embodiment, each power source 150-1-150-12 may be associated with a user (not shown), rather than with a UNI as described in the previous embodiment, with each user respectively associated with one or more UNIs 120-1-120-12. If a user is associated with multiple UNIs 120, then the multiple UNIs 120 associated with the user may be associated with an individual power source 150-1-150-12. Further, each UNI 120 may be associated multiple users within the MDU.

FIG. 1C is a block diagram illustrating an example deployment of an example embodiment of the present invention in an apartment building 102 (i.e., MDU). In this example embodiment, the apartment building includes multiple dwellings, such as apartment units 102-1-102-12. An MDU ONT 105 may be located in a shared space, such as a basement and is connected to a power source 155, including a primary AC power source 156a and a battery backup power source 156b. The MDU ONT 105 is also connected to power sources 150-1-150-12 respectively associated with each of the UNIs 120-1-120-12, each having a primary AC power source 151a-1-151a-12 and a battery backup power source 151b-1-151b-12. The power sources may provide power to the MDU ONT 105 to support MDU ONT functions that may be attributed to a particular UNI (e.g., supporting services on the UNI, such as voice, data, and video services, or other similar user services that may be supported by the MDU ONT 105). The power sources 150-1-150-12 may be distributed throughout the apartment building 102 in each of the apartment units 102-1-102-12 or, alternatively, may be at a central location or shared space, such as the basement. CPE devices 140, such as an IP telephone, an STB 145, a BHR 147, or a telephone 149, also are distributed throughout the apartment building 102.

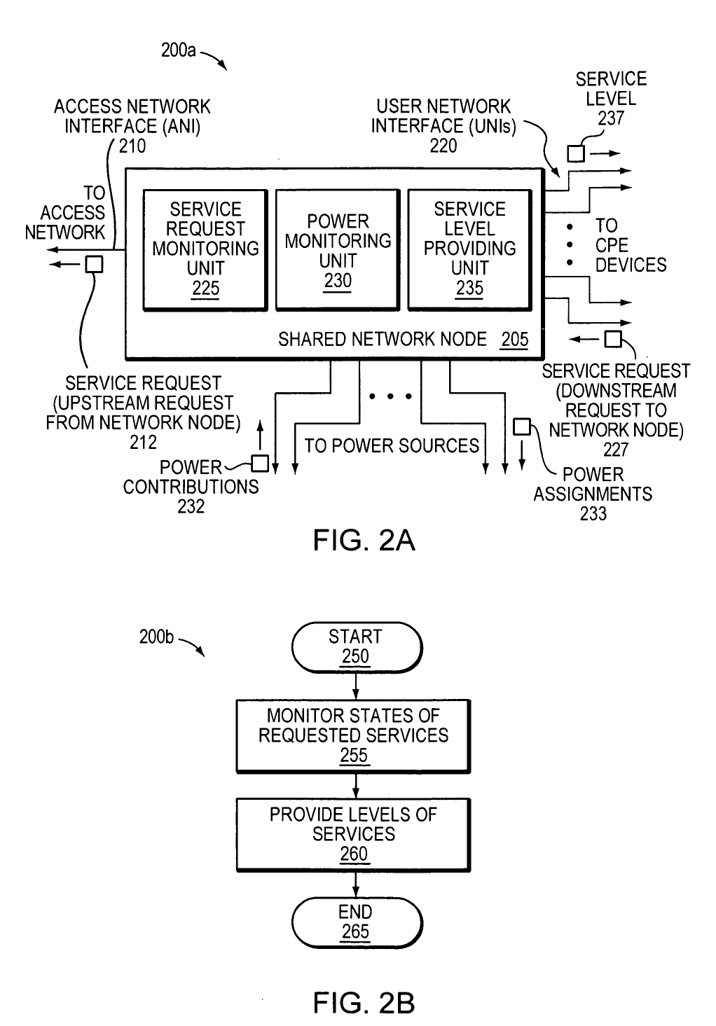

FIG. 2A is a block diagram illustrating an example embodiment apparatus, such as a shared network node 205, for providing service to a network node. The shared network node 205 includes an ANI 210 and multiple UNIs 220. The apparatus further includes a service request monitoring unit 225 configured to monitor states of requested services 227 from respective multiple users of the shared network node and upstream service requests 212 from the ANI 210 to the Access Network. The apparatus also includes a power monitoring unit 230 configured to monitor multiple power sources associated with the multiple users. The shared network node may be configured to operate on power from the multiple power sources respectively configured to contribute 232 to power the ANI and configured to be assigned 233 to power the multiple UNIs. A service level providing unit 235 is configured to provide levels of services 237 to the respective multiple users based on the states of requested services 227 and on the contribution of power sources 232 associated with the respective multiple users to power the ANI 210 and respective states of available power to power the multiple UNIs 220.

The power sources may be primary power sources (e.g., AC power), backup power sources (e.g., battery backup power), or a combination of primary and backup power sources. Further, the network node may provide services to an Optical Network Unit (ONU) or an Optical Network Terminal (ONT).

The network node 205 may further include an activity monitor configured to monitor activity on an interface of the network node (e.g., a UNI), an upstream request monitor configured to monitor upstream requests from the network node (e.g., from the ANI 210), and a downstream request monitor configured to monitor downstream requests to the network node (e.g., to the ANI 210). Moreover, the network node 205 may include a contribution adjustment unit configured to change contributions of power 232 from the power sources to power the ANI 210 dynamically as a function of requested 227 or provided 237 services from/to at least one user from the power sources. The network node 205 also may include a power source available to the multiple users to support priority services via the network node 205. Priority services may be emergency services or premium subscription services subscribed to by the users.

The service level providing unit 235 may be further configured to disable non-priority services to users associated with a power source having a state of available power inadequate to support the requested services for the respective users. The service level providing unit 235 may further be configured to associate users with the power sources on a one-to-one basis, one-to-many basis, and many-to-one basis. Also, the service level providing unit may be configured to accept provisioning information from a management node (e.g., EMS 117 of FIG. 1) relating to at least one of assignment of users to power sources or usage parameters of the power sources.

FIG. 2B is a flow diagram 200b illustrating an example embodiment method for providing services by a network node. After starting 250, states of requested services from respective multiple users on the shared network node are monitored 255. In this example embodiment, the shared network node includes an ANI and multiple UNIs, and operates on power from power sources associated with the multiple users respectively contributing to power the ANI and being assigned to power the multiple UNIs. Levels of service are then provided 260 to the respective multiple users based on the states of requested services and on the contribution of the power sources associated with the respective multiple users to power the ANI and respective states of available power to power the multiple UNIs. The method then ends 265.

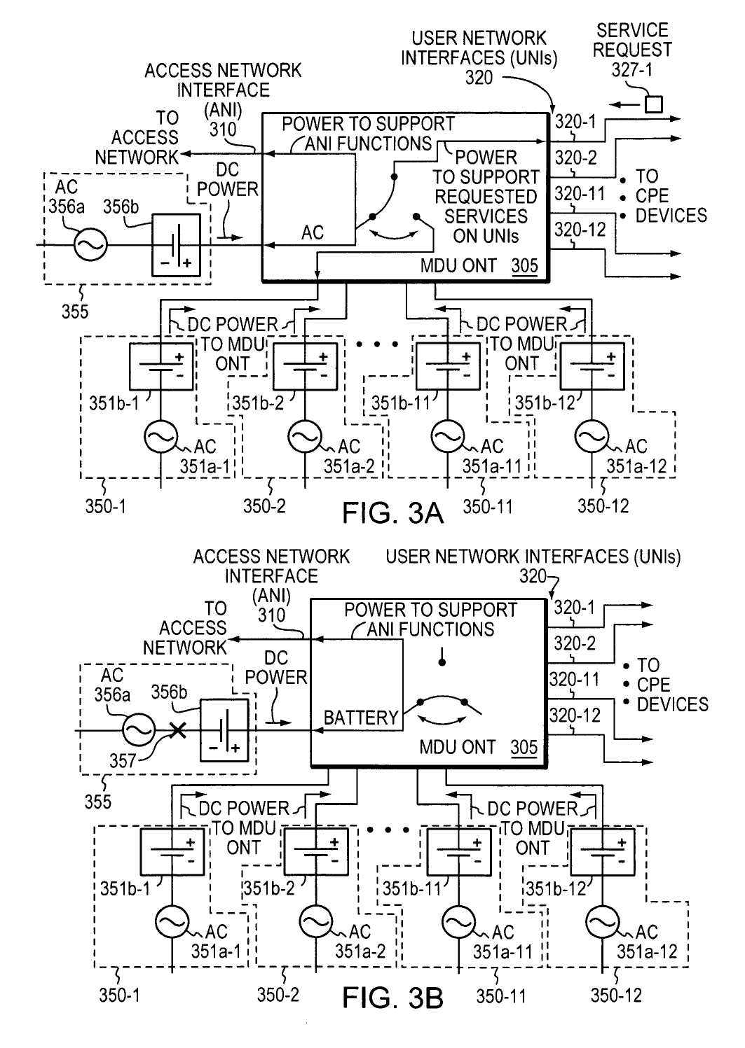

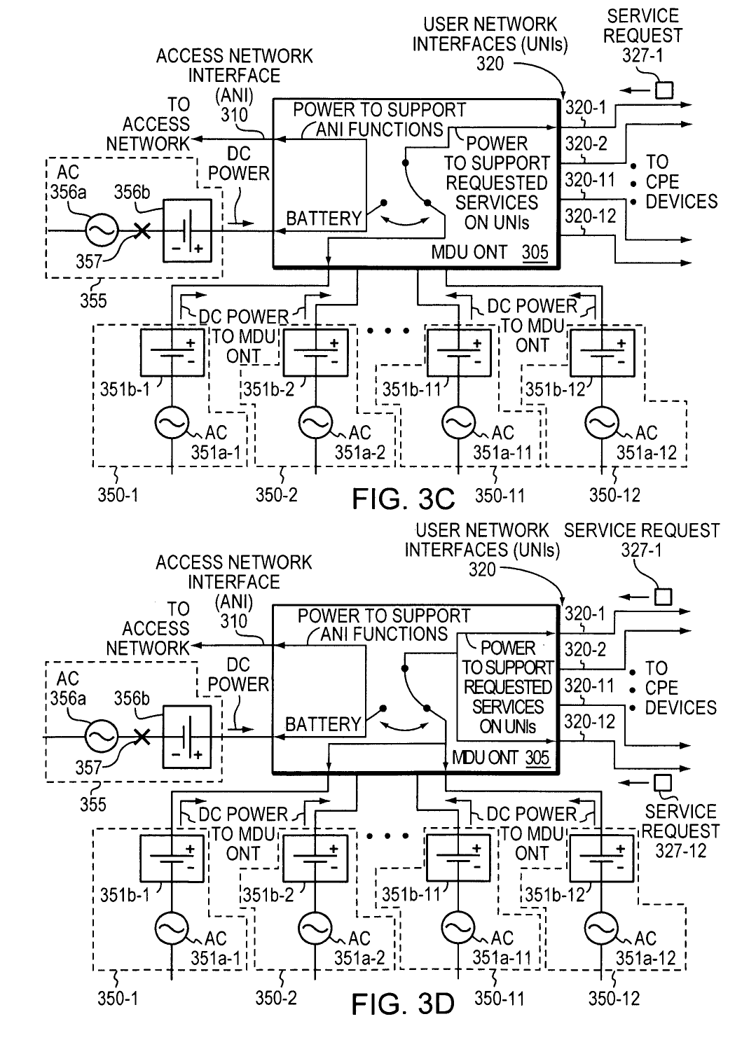

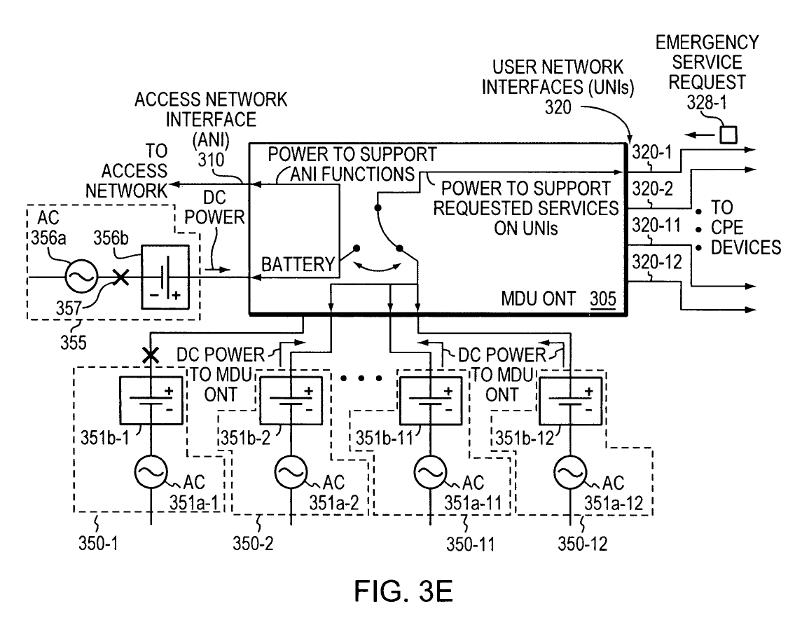

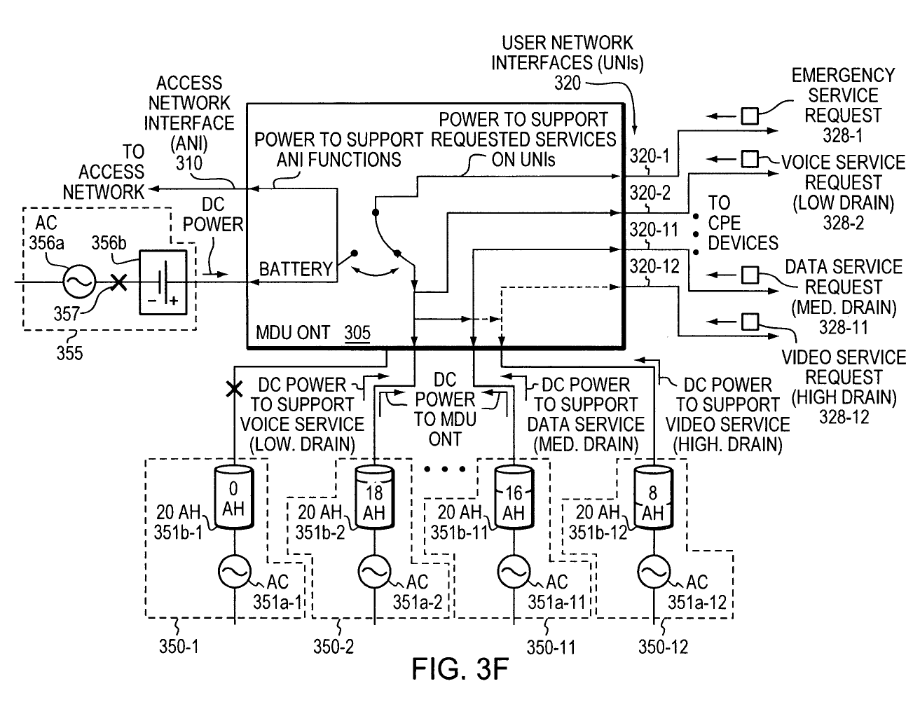

FIGS. 3A-3D illustrate example embodiments of the present invention in various states of power provided by power sources to a first UNI 320-1. However, it should be understood that power may be provided simultaneously to multiple UNIs 320-1-320-12. However, for clarity in these example embodiments, the selection of power to support services provided by an MDU ONT 305 over multiple UNIs 320 is illustrated for only one UNI 320-1. Therefore, the teachings of the selection of power to support services over the first UNI 320-1 are applicable to the selection of power to support services over all other UNIs 320-2-320-12.

Further, it should be understood that connections from the UNIs 320-1-320-12 to CPE devices (e.g., CPE devices of FIG. 1) (not shown) and connections to the power supplies 350-1-350-12 associated with the UNIs 320-1-320-12 may be made over separate physical connections (e.g., cables), as illustrated, or may be carried over a composite cable to carry electrical power as well as a service provider's data payload, including voice, data, video, physical layer information, such as converted Physical Layer Operations, Administration And Maintenance (PLOAM) messages or special protocol packets and management data, such as ONT Management Control Interface (OMCI) channel data and upgrade data. Further, the composite cable may carry signals from the user devices to the MDU ONT 305, such as low battery, missing battery, and power failure signals.

FIG. 3A is a block diagram illustrating an example embodiment MDU ONT 305 in a state of power supplied by an MDU ONT power source 355, such as AC power source 356a. In this example embodiment, the MDU ONT 305 receives primary power from the AC power source 356a while AC power is available. In this example embodiment, a first UNI 320-1 actively requests services 327-1, with the services on the MDU ONT 305 to the first UNI 320-1 powered from the AC power source 356a. For example, services requested by user devices on the first UNI 320-1 are supported using power from the MDU ONT's AC power source 356a. Further, secondary power for services that are common to all UNIs 320-1-320-12 is provided by an MDU ONT battery backup power source 356b. Secondary power for services attributable to a particular UNI, such as the first UNI 320-1, are provided by the battery backup power source 350-1 associated with the first UNI 320-1.

FIG. 3B is a block diagram illustrating an example embodiment MDU ONT 305 in a state of power in which there is a disruption in primary power, such as AC power 356a, from the MDU ONT power source 355 to the MDU ONT 305 (as indicated by the “X” 357). In this example embodiment, none of the UNIs 320 actively requests service (in contrast to the service request 327-1 of FIG. 3A). Therefore, with the disruption in AC power 356a, the MDU ONT 305 only supports functions on the ANI 310, and there being no service requests on the UNIs 320, the MDU ONT 305 receives secondary power from the MDU ONT power source 355, such as from a battery backup power source 356b. Therefore, the MDU 305 operates from its central battery backup power supply 356b that allows it to be ranged and monitors each UNI 320 for activity.

FIG. 3C is a block diagram illustrating an example embodiment MDU ONT 305 in a state of power, similar to the state of power illustrated in FIG. 3B, in which there is a disruption in primary power, such as AC power 356a, from the MDU ONT power source 355 to the MDU ONT 305 (as indicated by the “X” 357). However, in this example embodiment, a user of a first UNI 320-1 actively requests service 327-1. When the first UNI 320-1 is detected as active, the MDU ONT 305 transitions smoothly from receiving power from the MDU ONT battery backup power source 356b to operating from a battery backup power source associated with the active UNI 320-1, such as a first user battery backup power source 351b-1, to support requested services to user devices on the first UNI 320-1. The transition from power from the MDU ONT battery backup power source 356b to the battery backup power source 351b-1 associated with the active UNI 320-1 may be performed by a multiple input DC to DC transformer having a single output or multiple outputs.

The MDU ONT 305 battery backup power source 356b may be used by the MDU ONT 305 to monitor other interfaces on the MDU ONT 305 and support MDU ONT functions on the ANI 310. Alternatively, however, the MDU ONT 305 may allow power from the battery backup power sources 351b-1 associated with the active UNI 320-1 to provide power to support MDU ONT functions on the ANI 310 and other relevant interfaces. In this manner, power required to support activity associated with the active UNI 320-1, such as activity on the ANI 310 to support MDU ONT functions, is provided by the user with the active UNI 320-1. In other words, the burden of supporting services requested 327-1 at a time of a state of unavailable primary AC power 356a is born by users requesting the services and is not carried by users not requesting services (e.g., users of UNIs 320-2-320-12). Therefore, the battery backup power source sources 350-2-350-12 associated with users not requesting services have battery backup power available when those users do request services.

FIG. 3D is a block diagram illustrating an example embodiment MDU ONT 305 in a state of power, similar to the state of power illustrated in FIGS. 3B and 3C, in which there is a disruption in primary power, such as AC power 356a, from the MDU ONT power source 355 to the MDU ONT 305 (as indicated by the “X” 357). However, in this example embodiment, service requests 327-1, 327-12 are detected on a plurality of UNIs 320-1, 320-12. As a result of detecting activity on the active UNIs 320-1, 320-12, the MDU ONT 305 selects the power sources 350-1, 350-12 associated with the active UNIs 320-1, 320-12 to support requested services to user devices on the active UNIs 320-1, 320-12. Based on this selection, users requesting services are selected to provide the battery backup power necessary to support the services when the primary AC power source 356a for the MDU ONT 305 is unavailable. As a result, users requesting many services, services over a long period of time, or services that require a great amount of battery backup power to support do not unfairly dominate any one shared battery backup power source, as in traditional ONTs, but are limited to power available at the battery backup power source 351b-1, 351b-12 associated with the UNI 320-1, 320-12 used by the user.

The MDU ONT 305 battery backup power source 356b is still used by the MDU ONT 305 to monitor other interfaces on the MDU ONT 305 and support MDU ONT functions on the ANI 310. Alternatively, however, it should be understood that when multiple UNIs 320-1, 320-12 are active, the MDU ONT 305 may allow power from all associated battery backup power sources 351b-1, 351b-12 to provide power to support MDU ONT functions on the ANI 310 and other relevant interfaces. In this manner, power required to support activity common to all active UNIs 320-1, 320-12, such as activity on the ANI 310 to support MDU ONT functions, is shared by all users with active UNIs 320-1, 320-12.

In other words, the burden of supporting services requested 327-1, 327-12 at a time of a state of unavailable primary AC power 356a is born by users requesting the services (e.g., users of UNIs 320-1, 320-12) and is not carried by users not requesting services (e.g., users of UNIs 320-2-320-11). Therefore, that the battery backup power source sources 350-2-350-11 associated with users not requesting service have battery backup power available when those users do request services.

FIG. 3E is a block diagram illustrating an example embodiment MDU ONT 305 in a state of power similar to the state of power illustrated in FIGS. 3B, 3C and 3D, in which there is a disruption in primary power, such as AC power 356a, from the MDU ONT power source 355 to the MDU ONT 305 (as indicated by the “X” 357). In this example embodiment, a user of a first UNI 320-1 actively requests service 328-1, such as emergency or priority services. However, the battery backup power supply 351b-1 associated with the UNI 320-1 over which the user requests service 328-1 is inactive, missing, or fails to have power adequate to support the service requested. In order to support the service requested 328-1, the MDU ONT 305 may allocate power from the MDU ONT 305 battery backup power source 356b. Alternatively, the MDU ONT 305 may allocate power from all, or a subset of, the battery backup power supplies 351b-2-351b-12 associated with UNIs 320-2-320-12 not requesting emergency or other priority service.

The MDU ONT 305 battery backup power source 356b may be used by the MDU ONT 305 to monitor other interfaces on the MDU ONT 305 and support MDU ONT functions on the ANI 310. Alternatively, however, the MDU ONT 305 may allow power from the battery backup power sources 351b-2-351b-12 associated with the inactive UNIs 320-2-320-12 to provide power to support MDU ONT functions on the ANI 310 and other relevant interfaces. In this manner, power required to support activity associated with the active UNI 320-1, such as activity on the ANI 310 to support MDU ONT functions, is provided by other users with the inactive UNIs 320-2-320-12. In other words, because the user of the active UNI 320-1 is requesting emergency or priority service 328-1, the burden of supporting services requested 328-1 at a time of a state of unavailable primary AC power 356a is born by other users not requesting the services (e.g., users of UNIs 320-2-320-12). In this scenario, burdening other users with supporting requested emergency or priority services 328-1 is acceptable because of the nature of the services requested 328-1. Users requesting emergency or other priority services may be charged a fee for being provided backup power from battery backup power supplies 350-2-350-12 associated with other users. Users providing backup power to the user requesting emergency or other priority service may be credited all or a portion of the fee charged for providing the support.

FIG. 3F is a block diagram illustrating an example embodiment MDU ONT 305 in a state of power similar to the state of power illustrated in FIGS. 3B, 3C, 3D and 3E, in which there is a disruption in primary power, such as AC power 356a, from the MDU ONT power source 355 to the MDU ONT 305 (as indicated by the “X” 357). In this example embodiment, the battery backup power supplies 351b have a rated capacity of 20 Amp-Hours (AH). The UNIs 320-1-320-12 receive an emergency service request 328-1, a voice service request 328-2, a data service request 328-11 and a video service request 328-12, respectively.

The MDU ONT 305 may allocate power from the battery backup power supplies 351b to support services on the UNIs 320. For example, a second battery backup 351b-2 may support voice services associated with the voice service request 328-2 received on the second UNI 320-2. Voice services typically are low drain services, meaning they require relatively little power to support, and will drain the second battery backup 351b-2 slowly. Therefore, the second battery backup 351b-2 has only been drained to a capacity of 18 AH. Similarly, an eleventh battery backup 351b-11 may support data services associated with the data service request 328-11 received on the eleventh UNI 320-11. Data services typically are medium drain services, meaning they require more power than voice services to support. Therefore, the eleventh battery 351b-11 has only been drained to a capacity of 16 AH. Likewise, a twelfth battery backup 351b-12 may support video services associated with the video service request 328-12 received on the twelfth UNI 320-12. Video services typically require a relatively high amount of power to support and typically are high drain services. Therefore, the twelfth battery backup 351b-12 has been drained to a capacity of 8 AH.

In certain embodiments, the MDU ONT 305 may cease allocating power from a battery backup if its capacity reaches a certain capacity. For example, the twelfth battery backup 351b-12, allocated by the MDU ONT 305 to support services associated with the video service request 328-12 received on the twelfth UNI 320-12, may be drained to a certain level, such as 8 AH as described above, over time as it supports services on the UNI 320-12. Upon reaching such a threshold, the MDU ONT 305 may cease supporting the services on the UNI 320-12, particularly if the requested services are not emergency services, so that there is an adequate supply of power to support emergency, or lifeline, services at a later time.

If the requested services are emergency services, such as the emergency services 328-1 requested on the first UNI 320-1, the MDU ONT 305 may attempt to use the battery backup 351b-1 associated with the first UNI 320-1. However, due to use, failure or other unavailability, the first battery backup 351b-1 has an actual capacity of 0 AH and is unable to supply backup power to the MDU ONT 305 to support emergency services 328-1 on the first UNI 320-1. In order to support the requested emergency services 328-1 received on the first UNI 320-1, the MDU ONT 305 may allocate power from all, or a subset of, the other battery backup power supplies 351b-2-351b-12. For example, in addition to providing battery backup power to support services associated with the service requests 328-2-328-12 received on the UNIs 320-2-320-12, the battery backup power supplies 351b-2-351b-12 also may be allocated by the MDU ONT 305 to provide battery backup power to support emergency services associated with the emergency service request 328-1 received on the first UNI 320-1 for which there is insufficient battery backup power available at its associated battery backup power supply 351b-1. However, if a battery backup, such as the twelfth battery backup 351b-12, has reached a threshold, such as the 8 AH threshold discussed above, the MDU ONT 305 optionally may suspend allocation of that battery backup 351b-12 to support the emergency service.

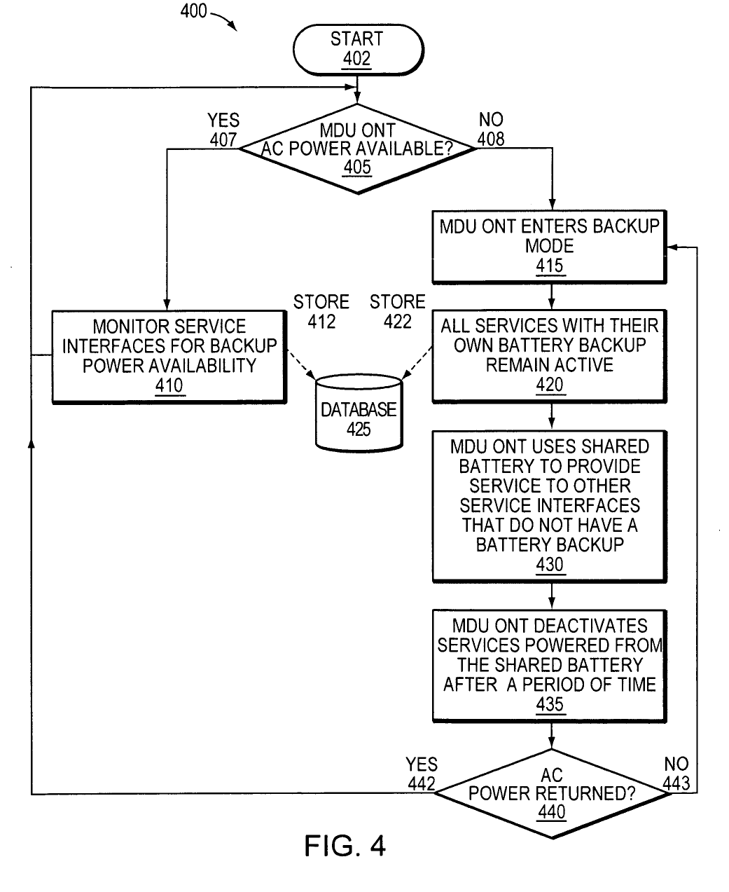

FIG. 4 is a flow diagram 400 illustrating an example embodiment method by which an MDU ONT (e.g., MDU ONT 105 of FIG. 1) may provide backup power to user devices (e.g., CPE devices 140 of FIG. 1). First, the MDU ONT monitors (405) primary MDU ONT AC power (e.g., AC power source 156a of FIG. 1). If primary AC power is available (407), the MDU ONT monitors all service interfaces (410) (e.g. UNIs 120 of FIG. 1) for backup power availability. However, if AC power is not available (408), the MDU ONT enters a backup mode (415). Interfaces supporting services having their own battery backup (e.g., battery backup power sources 151b-1-151b-12 of FIG. 1) remain active indefinitely (420), with backup power information being stored in a database (425). The MDU ONT then uses its central battery backup (430) (e.g., battery backup power supply 156b of FIG. 1) to provide power for other service interfaces that do not have a battery backup (i.e., those services that do not remain active indefinitely (420)). After a predetermined amount of time, the MDU ONT deactivates (435) services powered from the central battery backup. These services are no longer available until a battery is connected at the user's premises, or until AC power is restored to the MDU ONT. However, other embodiments may allow emergency or other priority services to be supported, if needed. The MDU ONT then determines (440) whether AC power has been restored. If AC power has been restored (442), backup power information is stored (445) in a database (425). However, if AC power is not restored (443), then the MDU ONT remains in backup mode (415).

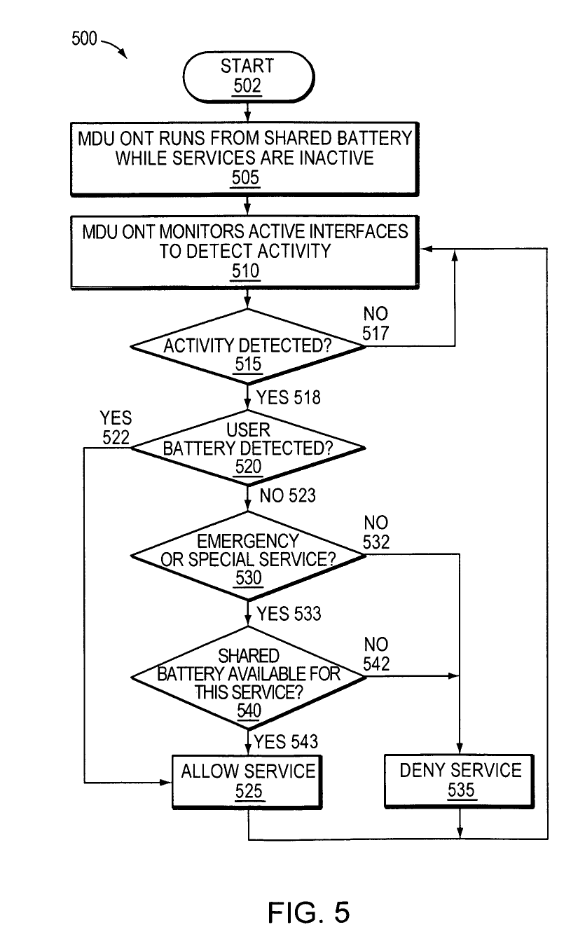

FIG. 5 is a flow diagram 500 illustrating an example embodiment method by which an MDU ONT (e.g., MDU ONT 305 of FIG. 3C) may support emergency or priority services. While the MDU ONT's main AC power supply (e.g., AC power source 356a of FIG. 3C) is inactive, the MDU ONT operates (505) from its central battery backup power supply (e.g., battery backup power supply 356b of FIG. 3C) while services on the UNIs (e.g., UNIs 320 of FIG. 3C) are inactive. In this mode, the MDU ONT may be in a sleep mode or may be running local diagnostics (i.e., a very low power mode) and attempting to detect user activity on UNIs. The MDU ONT monitors (510) all UNIs to detect user activity. The MDU ONT then determines whether activity is detected (515). If activity is not detected (517) on the UNIs, then the MDU ONT continues to operate from its central battery backup. However, if activity is detected (518) on one or more UNIs, the MDU ONT determines whether there is an operational backup battery power supply associated with the active UNIs (520) (e.g., battery backup power supplies 351b-1-351b-12 of FIG. 3C). If there is an operational battery (522), then the MDU allows the service (525). However, if there is not operational battery (523) (e.g., battery backup power supply 351b-1 of FIG. 3E), the MDU ONT determines whether the requested services are emergency or other priority services (530). If the requested service is not an emergency or priority service (532), the MDU ONT denies the requested service (535). However, if the requested service is an emergency or priority service (533) (e.g., requested service 328-1 of FIG. 3E), the MDU ONT determines whether there is adequate power to support this service (540) provided by the either the MDU ONT's central battery backup power supply (e.g., battery backup power supply 356b of FIG. 3E) or battery backup power supplies associated with other inactive UNIs (e.g., battery backup power supplies 356b-2-356b-12 of FIG. 3E). If there is not adequate backup power (542), the MDU ONT denies the service (535). However, if there is adequate power (543), the MDU ONT allows the service (525). After denying services (535), the MDU ONT returns to monitor UNIs for activity (510).

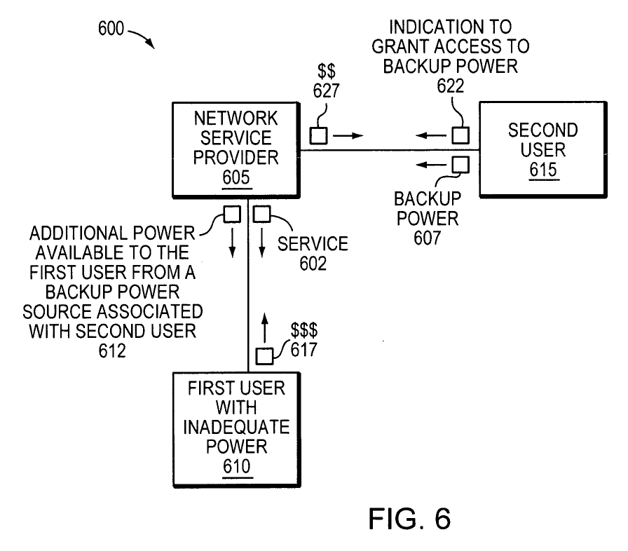

FIG. 6 is a diagram illustrating a service model 600 for a service provider 605 to provide service 602 to a first user 610 and to generate revenue 617 from the first user 610 through sale of the service 602 provided according to the service model. In this example, embodiment, a network node of the first user 610 operates in a state of available backup power inadequate to support the requested services for the first user. The service provider 605 may draw backup power 607 from a second user 615 and provide the additional power 612 to the first user 610. In exchange for making additional power 612 available to the first user 610 from a backup power source associated with the network node of the second user 615, the first user 610 pays a sum of money 617 to the service provider 605. Alternatively, the second user 615 may provide an indication 622 to the service provider 605 that the second user 615 is willing to grant access to the second user's backup power to other users, such as the first user 610. In exchange for the voluntary access to backup power, the second user 615 may be credited a sum of money 627 by the service provider 605. This sum of money 627 may be all or a portion of the sum of money 617 paid by the first user 610 to the service provider 605 for the additional power.

Further, user services supported by the MDU ONT at a time of operation of the MDU ONT under battery backup power may be prioritized. For example, the first user 610 may subscribe to a level of service that has priority over a level of service subscribed to by the second user 615. Under this subscription model, the second user 615 may use services supported by the MDU ONT operating under backup power until the first user 610 requests service. When the first user 610 requests service from the MDU ONT, the services for the second user 615 are terminated.

Example embodiments of the present invention also allow service providers and business owners to save on electricity costs by distributing the cost of powering the MDU ONT to the users, such as paying customers. Further, this service model allows the MDU ONT to provide relevant services from one central location, but allows subscribers to purchase their own battery backup power supply from the service provider and install it at a convenient location in the customers premises. Subscribers may select a battery backup power supply from various batteries ranging in rated capacity. Moreover, an operator of an MDU, such as a condominium association, may purchase battery backup power supplies from the service provider and distribute or resell the battery backup power supplies to tenants. Alternatively, the MDU operator may group the battery backup power supplies for each customer premises together and charge a fee to tenants, such as an increased condominium association fee, to account for the increase cost.

Further, it should be understood that backup power sources are not limited to battery backup power supplies. Other backup power sources may include AC backup power sources, such as traditional fuel-burning backup generators, solar panels, hydroelectric generators, geothermal generators, and wind turbines. Services in the MDU ONT may be prioritized during operation under an AC backup power supply, even though there is no complete AC failure, because there is a failure in the primary power source. Moreover, it should be understood that charging a battery, such as a battery in a battery backup power source, may be the highest-priority use of the backup power source, and other services in the MDU ONT may be disabled while the battery charges.

While this invention has been particularly shown and described with references to example embodiments thereof, it will be understood by those skilled in the art that various changes in form and details may be made therein without departing from the scope of the invention encompassed by the appended claims.

Implementations of flow diagrams illustrating example embodiments may be implemented in a form of hardware, firmware, software, or combinations thereof. If implemented in software, the software may be any suitable language, stored on a computer-readable medium, and may be loaded and executed by a processor. The processor can be any general or application-specific processor that can execute the software in a manner consistent with the example embodiments of the present invention, as claimed and illustrated herein.

What is claimed is:

1. A method of providing services by a network node, the method comprising:
monitoring states of requested services from respective multiple users of a shared network node, having an Access Network Interface (ANI) and multiple User Network Interfaces (UNIs), operating on power from power sources associated with the multiple users respectively contributing to power the ANI and being assigned to power the multiple UNIs; and
providing levels of services to the respective multiple users based on the states of requested services and on the contribution of the power sources associated with the respective multiple users to power the ANI and respective states of available power to power the multiple UNIs.

2. The method of claim 1 wherein providing the levels of services in part based on the contribution of the power sources is based on primary power to the network node provided by the power sources.

3. The method of claim 1 wherein providing the levels of services in part based on the contribution of the power sources is based on backup power to the network node provided by the power sources.

4. The method of claim 1 wherein providing the levels of services in part based on the contribution of the power sources is based on combination of primary and backup power to the network node provided by the power sources.

5. The method of claim 1 wherein the network node is an Optical Network Unit (ONU) or an Optical Network Terminal (ONT) and wherein monitoring states of requested services includes monitoring states of requested services from ONUs or ONTs associated with the respective multiple users.

6. The method of claim 1 wherein monitoring the states of requested services includes monitoring activity on an interface of the network node.

7. The method of claim 1 wherein monitoring the states of requested services includes monitoring upstream requests from the network node.

8. The method of claim 1 wherein monitoring the states of requested services includes monitoring downstream requests to the network node.

9. The method of claim 1 further including dynamically changing contributions of power from the power sources to power the ANI as a function of requested or provided services from or to at least one user associated with the power sources.

10. The method of claim 1 further including providing power from a power source available to the multiple users to support priority services via the network node.

11. The method of claim 10 wherein priority services are emergency services.

12. The method of claim 10 wherein priority services are premium subscription services subscribed to by the users.

13. The method of claim 10 further including disabling non-priority services to users associated with a power source having a state of available power inadequate to support the requested services for the respective users.

14. The method of claim 1 further including associating users with the power sources on a one-to-one basis or many-to-one basis.

15. The method of claim 1 further including accepting provisioning information from a management node relating to at least one of the following: levels of services, assignment of users to power sources, or usage parameters of the power sources.

16. The method of claim 1 wherein services include voice, data, and video services.

17. A network node comprising:
an Access Network Interface (ANI);
multiple User Network Interfaces (UNIs);
a service request monitoring unit configured to monitor states of requested services from respective multiple users of the shared network node;
a power monitoring unit configured to monitor multiple power sources associated with the multiple users, the shared network node configured to operate on power from the multiple power sources, the multiple power sources configured to respectively contribute to power the ANI and configured to be assigned to power the multiple UNIs; and
a service level providing unit configured to provide levels of services to the respective multiple users based on the states of requested services and on the contribution of power sources associated with the respective multiple users to power the ANI and respective states of available power to power the multiple UNIs.

18. The network node of claim 17 wherein the power sources are primary power sources.

19. The network node of claim 17 wherein the power sources are backup power sources.

20. The network node of claim 17 wherein the power sources are a combination of primary and backup power sources.

21. The network node of claim 17 wherein the network node provides services to an Optical Network Unit (ONU) or an Optical Network Terminal (ONT).

22. The network node of claim 17 further comprising an activity monitor configured to monitor activity on an interface of the network node.

23. The network node of claim 17 further comprising an upstream request monitor configured to monitor upstream requests from the network node.

24. The network node of claim 17 further comprising a downstream request monitor configured to monitor downstream requests to the network node.

25. The network node of claim 17 further comprising a contribution adjustment unit configured to dynamically change contributions of power from the power sources to power the ANI as a function of requested or provided services from/to at least one user associated with the power sources.

26. The network node of claim 17 further comprising a power source available to the multiple users to support priority services via the network node.

27. The network node of claim 26 wherein priority services are emergency services.

28. The network node of claim 26 wherein priority services are premium subscription services subscribed to by the users.

29. The network node of claim 26 wherein the service level providing unit is further configured to disable non-priority services to users associated with a power source having a state of available power inadequate to support the requested services for the respective users.

30. The network node of claim 17 wherein the service level providing unit is further configured to associate users with the power sources on a one-to-one basis or many-to-one basis.

31. The network node of claim 17 wherein the service level providing unit is further configured to accept provisioning information from a management node relating to at least one of assignment of users to power sources or usage parameters of the power sources.

32. The network node of claim 17 wherein services include voice, data, and video services.

33. A computer-readable medium having computer-readable code embedded therein that causes a computer, upon execution of the code, to:
monitor states of requested services from respective multiple users of a shared network node, the shared network node having an Access Network Interface (ANI) and multiple User Network Interfaces (UNIs), operating on power from power sources associated with the multiple users respectively contributing to power the ANI and being assigned to power the multiple UNIs; and
provide levels of services to the respective multiple users based on the states of requested services and on the contribution of power sources associated with the respective multiple users to power the ANI and respective states of available power to power the multiple UNIs.

34. A method for providing services to a user, the method comprising:
providing services to a network node of a first user at a time of a state of available backup power inadequate to support the requested services for the first user;
making additional power available to the first user from a backup power source associated with a network node of a second user, the first and second network nodes connected to a shared network node; and
collecting a fee from the first user as payment for the additional power made available to the network node of the first user at the time of the state of inadequate backup power to provide the services to the first user.

35. The method of claim 34 wherein the second user indicates a desire to grant access to backup power to other users, the method further comprising crediting the second user for granting access to power from the backup power source of the second user.

36. The method of claim 34 wherein the services are priority services beyond regulated emergency services.
